(19) United States
(12) Patent Application Publication
(10) Pub. No.: US 2013/0003151 A1
(43) Pub. Date: Jan. 3, 2013

(54) HOLOGRAPHIC STORAGE METHOD AND ARTICLE

(75) Inventors: Michael T. Takemori, Rexford, NY (US); Mark A. Cheverton, Mechanicville, NY (US); Andrew A. Burns, Niskayuna, NY (US); Sumeet Jain, Schenectady, NY (US)

(73) Assignee: SABIC INNOVATIVE PLASTICS IP B.V., PX Bergen op Zoom (NL)

(21) Appl. No.: 13/171,640

(22) Filed: Jun. 29, 2011

(51) Int. Cl. G03H 1/02; G03H 1/04

(52) U.S. Cl. 359/3; 359/30

(57) ABSTRACT

A method of recording a holographic record is described. According to this method, a holographic recording medium is exposed to a desired pattern, shape, or image from a coherent light source emitting light at one or more wavelengths to which the holographic recording medium is sensitive. In this method, light having the desired pattern, shape, or image to which the holographic recording medium is exposed is diffracted by a spatially homogeneous optical diffraction element so that the holographic recording medium is exposed to a plurality of interfering light beams, thereby forming a holographic record in the holographic recording medium. Holographic recording articles are described that include a holographic recording medium and a spatially homogeneous optical diffraction element.

### BACKGROUND

The present disclosure relates to articles that incorporate holograms, more particularly volume transmission and reflection holograms. Methods of making and using the same are also disclosed.

Holograms are an increasingly popular mechanism for the authentication of genuine articles, whether it is for security purposes or for brand protection. The use of holograms for these purposes is driven primarily by the relative difficulty with which they can be duplicated. Holograms are created by interfering two coherent beams of light to create an interference pattern and storing that pattern in a holographic recording medium. Information or imagery can be stored in a hologram by imparting the data or image to one of the two coherent beams prior to their interference. The hologram can be read out by illuminating it with a beam matching either of the two original beams used to create the hologram and any data or images stored in the hologram will be displayed. As a result of the complex methods required to record holograms, their use for authentication can be seen on articles such as credit cards, software, passports, clothing, and the like. In addition, the inherent properties of holograms (vivid coloration, 3-dimensional effects, angular selectivity, etc.) have long attracted the interest of artists and advertisers as a medium for generating eye-catching displays for commercial or private use.

Two categories of holograms include surface relief structure holograms and volume holograms. Many of the holograms used in display, security or authentication applications are of the surface relief type, in which the pattern and any data or image contained therein is stored in the structure or deformations imparted to the surface of the recording medium. While the initial holograms may be created by the interference of two coherent beams, duplicates can be created by copying the surface structure using techniques such as embossing. The duplication of holograms is convenient for the mass production of articles such as credit cards or security labels, but it also has the disadvantage that it makes the unauthorized duplication and/or modification of these holograms for use in counterfeit parts possible from the originals using the same mechanism.

Unlike surface holograms, volume holograms are formed in the bulk of a recording medium. Volume holograms have the ability to be multiplexed, storing information at different depths and different angles within the bulk recording material and thus have the ability to store greater amounts of information. In addition, because the pattern which makes up the hologram is embedded, copying cannot be done using the same techniques as for surface relief holograms. In addition, surface holograms are inherently polychromatic (rainbow-appearance), while volume holograms are capable of both monochromatic (at a desired wavelength) as well as polychromatic (either multicolored or rainbow-appearance), which enables greater control of the aesthetic features of volume holograms for display applications versus surface holograms.

While volume holograms can provide greater security against counterfeit duplication and greater aesthetic breadth than surface relief structure holograms, they generally require vibration-isolated, temperature-controlled recording equipment that must be maintained at physical tolerances of less than the writing light wavelength, typically on the order of hundreds of nanometers (e.g., 405 nm) in order to record well-defined, high diffraction efficiency holograms. Additionally, the laser sources, especially those used for traditional transmission holography in thick materials, must have long coherence lengths (e.g., centimeters to meters). All of this contributes to relatively high equipment costs for recording volume holograms. Accordingly, volume holograms have proven to be more time-consuming and expensive to mass produce because in many cases each holographic article must be individually exposed with interfering signal and reference light sources in order to produce the interference fringe patterns to create the holographic image. Mass production is even more problematic if it is desired to individualize or personalize individual holographic images, as the signal light source must be provided with different image information for each individualized holographic recording, which adds to the time, expense, and complexity of the holographic recording process. For example, individualized information such as photos, logos, serial numbers, images, and the like is often collected and/or maintained in a decentralized fashion at disparate locations, which would then require holographic recording equipment to be maintained and operated at a number of different locations, further adding to the required time, capital expense, and complexity.

Accordingly, there exists a need for new techniques for recording volume holograms that offer improved efficiency and/or lower cost. There also remains a need for new techniques for recording volume holograms with individualized images, information, or characteristics at improved efficiency and/or lower cost.

### SUMMARY

In an exemplary embodiment, a method of recording a volume holographic shape, pattern, or image is described. According to this method, a holographic recording medium is exposed to a desired pattern, shape, or image from a coherent light source emitting light at one or more wavelengths to which the holographic recording medium is sensitive. In this method, light having the desired pattern, shape, or image to which the holographic recording medium is exposed is diffracted by a spatially homogeneous optical diffraction element so that the holographic recording medium is exposed to a plurality of interfering light beams, thereby forming a holographic record in the holographic recording medium.

In another exemplary embodiment, an article for recording a holographic pattern, shape, or image comprises a holographic recording medium and a spatially homogeneous optical diffraction element.

### BRIEF DESCRIPTION OF THE DRAWINGS

Referring now to the Figures, which represent exemplary embodiments and wherein like elements may be numbered alike:

FIG. 1 represents an exemplary structure of an article for recording and displaying a holographic image;

FIG. 2 represents an article and configuration for recording a transmission hologram;

FIG. 3 represents an article and configuration for recording a transmission hologram;

FIG. 4 represents an article and configuration for recording a transmission hologram;

FIG. 5 represents an article and configuration for recording a reflection hologram;

FIG. 6 represents an article and configuration for recording a reflection hologram;

FIG. 7 represents an article and configuration for recording a reflection hologram;

FIG. 8 represents an article and configuration for recording a reflection hologram; and

FIG. 9 represents an article and configuration for recording a reflection hologram.

### DETAILED DESCRIPTION

The methods disclosed herein may be utilized with virtually any type of recording medium capable of recording interference fringe patterns for the recording of holograms. Such media may include media that comprise photochemically active dye(s) dispersed in a binder such as a thermoplastic binder as disclosed, for example, in U.S. patents or published patent applications US 2006/0078802A1, US 2007/0146835A1, U.S. Pat. No. 7,524,590, U.S. Pat. No. 7,102,802, US 2009/0082580A1, US 2009/0081560A1, US 2009/0325078A1, and US 2010/0009269A1, the disclosures of which are incorporated herein by reference in their entirety. Other media with which the methods disclosed herein may be used include photopolymer holographic recording media (as disclosed in e.g., U.S. Pat. No. 7,824,822 B2, U.S. Pat. No. 7,704,643 B2, U.S. Pat. No. 4,996,120 A, U.S. Pat. No. 5,013,632 A), dichromated gelatin, liquid crystal materials, photographic emulsions, and others as disclosed in P. Hariharan, Optical Holography—Principles, techniques, and applications 2^{nd}ed., Cambridge University Press, 1996, the disclosures of each of which are incorporated herein by reference in their entirety.

Many holographic recording media include a photosensitive material (e.g., a photochromic dye, photopolymer, photographic emulsion, dichromated gelatin, etc.). In an exemplary embodiment, the holographic recording medium may be a composition comprising a binder and the photochemically active material (e.g., photochromic dye) that is capable of recording a hologram. The binder composition can include inorganic material(s), organic material(s), or a combination of inorganic material(s) with organic material(s), wherein the binder has sufficient deformability (e.g., elasticity and/or plasticity) to enable the desired number of deformation states (e.g., number of different deformation ratios) for the desired recording. The binder should be an optically transparent material, e.g., a material that will not interfere with the reading or writing of the hologram. As used herein, the term “optically transparent” means that an article (e.g., layer) or a material capable of transmitting a substantial portion of incident light, wherein a substantial portion can be greater than or equal to 70% of the incident light. The optical transparency of the layer may depend on the material and the thickness of the layer. The optically transparent holographic layer may also be referred to as a holographic layer.

Exemplary organic materials include optically transparent organic polymer(s) that are elastically deformable. In one embodiment, the binder composition comprises elastomeric material(s) (e.g., those which provide compressibility to the holographic medium). Exemplary elastomeric materials include those derived from olefins, monovinyl aromatic monomers, acrylic and methacrylic acids and their ester derivatives, as well as conjugated dienes. The polymers formed from conjugated dienes can be fully or partially hydrogenated. The elastomeric materials can be in the form of homopolymers or copolymers, including random, block, radial block, graft, and core-shell copolymers. Combinations of elastomeric materials can be used.

Possible elastomeric materials include thermoplastic elastomeric polyesters (commonly known as TPE) include polyetheresters such as poly(alkylene terephthalate)s (particularly poly[ethylene terephthalate] and poly[butylene terephthalate]), e.g., containing soft-block segments of poly(alkylene oxide), particularly segments of poly(ethylene oxide) and poly(butylene oxide); and polyesteramides such as those synthesized by the condensation of an aromatic diisocyanate with dicarboxylic acids and a carboxylic acid-terminated polyester or polyether prepolymer. One example of an elastomeric material is a modified graft copolymer comprising (i) an elastomeric (i.e., rubbery) polymer substrate having a glass transition temperature (Tg) less than 10° C., more specifically less than −10° C., or more specifically −200° to −80° C., and (ii) a rigid polymeric superstrate grafted to the elastomeric polymer substrate. Exemplary materials for use as the elastomeric phase include, for example, conjugated diene rubbers, for example polybutadiene and polyisoprene; copolymers of a conjugated diene with less than 50 wt % of a copolymerizable monomer, for example a monovinylic compound such as styrene, acrylonitrile, n-butyl acrylate, or ethyl acrylate; olefin rubbers such as ethylene propylene copolymers (EPR) or ethylene-propylene-diene monomer rubbers (EPDM); ethylene-vinyl acetate rubbers; silicone rubbers; elastomeric C₁₋₈ alkyl(meth)acrylates; elastomeric copolymers of C₁₋₈ alkyl(meth)acrylates with butadiene and/or styrene; or combinations comprising at least one of the foregoing elastomers. Exemplary materials for use as the rigid phase include, for example, monovinyl aromatic monomers such as styrene and alpha-methyl styrene, and monovinylic monomers such as acrylonitrile, acrylic acid, methacrylic acid, and the C₁-C₆ esters of acrylic acid and methacrylic acid, specifically methyl methacrylate. As used herein, the term “(meth)acrylate” encompasses both acrylate and methacrylate groups.

Specific exemplary elastomer-modified graft copolymers include those formed from styrene-butadiene-styrene (SBS), styrene-butadiene rubber (SBR), styrene-ethylene-butadiene-styrene (SEBS), ABS (acrylonitrile-butadiene-styrene), acrylonitrile-ethylene-propylene-diene-styrene (AES), styrene-isoprene-styrene (SIS), methyl methacrylate-butadiene-styrene (MBS), and styrene-acrylonitrile (SAN).

Exemplary organic materials that can also be employed as the binder composition are optically transparent organic polymers. The organic polymer can be thermoplastic polymer(s), thermosetting polymer(s), or a combination comprising at least one of the foregoing polymers. The organic polymers can be oligomers, polymers, dendrimers, ionomers, copolymers such as for example, block copolymers, random copolymers, graft copolymers, star block copolymers; or the like, or a combination comprising at least one of the foregoing polymers. Exemplary thermoplastic organic polymers that can be used in the binder composition include, without limitation, polyacrylates, polymethacrylates, polyesters (e.g., cycloaliphatic polyesters, resorcinol arylate polyester, and so forth), polyolefins, polycarbonates, polystyrenes, polyamideimides, polyarylates, polyarylsulfones, polyethersulfones, polyphenylene sulfides, polysulfones, polyimides, polyetherimides, polyetherketones, polyether etherketones, polyether ketone ketones, polysiloxanes, polyurethanes, polyethers, polyether amides, polyether esters, or the like, or a combination comprising at least one of the foregoing thermoplastic polymers (either in admixture or co- or graft-polymerized), such as polycarbonate and polyester.

Exemplary polymeric binders are described herein as “transparent”. Of course, this does not mean that the polymeric binder does not absorb any light of any wavelength. Exemplary polymeric binders need only be reasonably transparent in wavelengths for exposure and viewing of a holographic image so as to not unduly interfere with the formation and viewing of the image. In an exemplary embodiment, the polymer binder has an absorbance in the relevant wavelength ranges of less than 0.2. In another exemplary embodiment, the polymer binder has an absorbance in the relevant wavelength ranges of less than 0.1. In yet another exemplary embodiment, the polymer binder has an absorbance in the relevant wavelength ranges of less than 0.01. Organic polymers that are not transparent to electromagnetic radiation can also be used in the binder composition if they can be modified to become transparent. For examples, polyolefins are not normally optically transparent because of the presence of large crystallites and/or spherulites. However, by copolymerizing polyolefins, they can be segregated into nanometer-sized domains that cause the copolymer to be optically transparent.

In one embodiment, the organic polymer and photochromic dye can be chemically attached. The photochromic dye can be attached to the backbone of the polymer. In another embodiment, the photochromic dye can be attached to the polymer backbone as a substituent. The chemical attachment can include covalent bonding, ionic bonding, or the like.

Examples of cycloaliphatic polyesters for use in the binder composition are those that are characterized by optical transparency, improved weatherability and low water absorption. It is also generally desirable that the cycloaliphatic polyesters have good melt compatibility with the polycarbonate resins since the polyesters can be mixed with the polycarbonate resins for use in the binder composition. Cycloaliphatic polyesters are generally prepared by reaction of a diol (e.g., straight chain or branched alkane diols, and those containing from 2 to 12 carbon atoms) with a dibasic acid or an acid derivative.

Polyarylates that can be used in the binder composition refer to polyesters of aromatic dicarboxylic acids and bisphenols. Polyarylate copolymers include carbonate linkages in addition to the aryl ester linkages, known as polyester-carbonates. These aryl esters may be used alone or in combination with each other or more particularly in combination with bisphenol polycarbonates. These organic polymers can be prepared, for example, in solution or by melt polymerization from aromatic dicarboxylic acids or their ester forming derivatives and bisphenols and their derivatives.

Blends of organic polymers may also be used as the binder composition for the holographic devices. Specifically, organic polymer blends can include polycarbonate (PC)-poly(1,4-cyclohexane-dimethanol-1,4-cyclohexanedicarboxylate) (PCCD), PC-poly(cyclohexanedimethanol-co-ethylene terephthalate) (PETG), PC-polyethylene terephthalate (PET), PC-polybutylene terephthalate (PBT), PC-polymethylmethacrylate (PMMA), PC-PCCD-PETG, resorcinol aryl polyester-PCCD, resorcinol aryl polyester-PETG, PC-resorcinol aryl polyester, resorcinol aryl polyester-polymethylmethacrylate (PMMA), resorcinol aryl polyester-PCCD-PETG, or the like, or a combination comprising at least one of the foregoing.

Binary blends, ternary blends and blends having more than three resins may also be used in the polymeric alloys. When a binary blend or ternary blend is used in the polymeric alloy, one of the polymeric resins in the alloy may comprise about 1 to about 99 weight percent (wt %) based on the total weight of the composition. Within this range, it is generally desirable to have the one of the polymeric resins in an amount greater than or equal to about 20, preferably greater than or equal to about 30 and more preferably greater than or equal to about 40 wt %, based on the total weight of the composition. Also desirable within this range, is an amount of less than or equal to about 90, preferably less than or equal to about 80 and more preferably less than or equal to about 60 wt % based on the total weight of the composition. When ternary blends of blends having more than three polymeric resins are used, the various polymeric resins may be present in any desirable weight ratio.

Exemplary thermosetting polymers that may be used in the binder composition include, without limitation, polysiloxanes, phenolics, polyurethanes, epoxies, polyesters, polyamides, polyacrylates, polymethacrylates, or the like, or a combination comprising at least one of the foregoing thermosetting polymers. In one embodiment, the organic material can be a precursor to a thermosetting polymer.

As noted above, the photoactive material is a photochromic dye. The photochromic dye is one that is capable of being written and read by electromagnetic radiation. When exposed to electromagnetic radiation of the appropriate wavelength, the dye undergoes a chemical change in situ and does not rely on diffusion of a photoreactive species during exposure to generate refractive index contrast. In one exemplary embodiment, the photochromic dyes can be written and read using actinic radiation i.e., from about 350 to about 1,100 nanometers. In a more specific embodiment, the wavelengths at which writing and reading are accomplished may be from about 400 nanometers to about 800 nanometers. In one exemplary embodiment, the reading and writing and is accomplished at a wavelength of about 400 to about 600 nanometers. In another exemplary embodiment, the writing and reading are accomplished at a wavelength of about 400 to about 550 nanometers. In one specific exemplary embodiment, a holographic medium is adapted for writing at a wavelength of about 405 nanometers. In such a specific exemplary embodiment, reading may be conducted at a wavelength of about 532 nanometers, although viewing of holograms may be conducted at other wavelengths depending on the viewing and illumination angles, and the diffraction grating spacing and angle. Examples of photochromic dyes include diarylethenes, dinitrostilbenes and nitrones.

An exemplary diarylethylene compound can be represented by formula (XI):

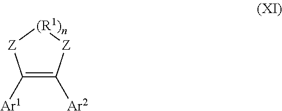

wherein n is 0 or 1; R¹ is a single covalent bond (C₀), C₁-C₃ alkylene, C₁-C₃ perfluoroalkylene, oxygen; or —N(CH₂)ₓCN wherein x is 1, 2, or 3; when n is 0, Z is C₁-C₅ alkyl, C₁-C₅ perfluoroalkyl, or CN; when n is 1, Z is CH₂, CF₂, or C═O; Ar¹ and Ar² are each independently i) phenyl, anthracene, phenanthrene, pyridine, pyridazine, 1H-phenalene or naphthyl, substituted with 1-3 substituents wherein the substituents are each independently C₁-C₃ alkyl, C₁-C₃ perfluoroalkyl, or fluorine; or ii) represented by following formulas:

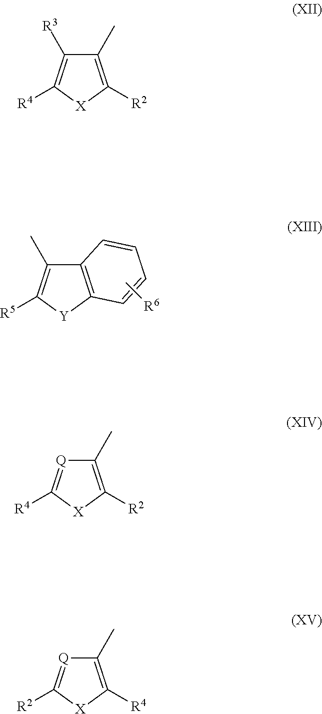

wherein R² and R⁵ are each independently C₁-C₃ alkyl or C₁-C₃ perfluoroalkyl; R³ is C₁-C₃ alkyl, C₁-C₃ perfluoroalkyl, hydrogen, or fluorine; R⁴ and R⁶ are each independently C₁-C₃ alkyl, C₁-C₃ perfluoroalkyl, CN, hydrogen, fluorine, phenyl, pyridyl, isoxazole, —CHC(CN)₂, aldehyde, carboxylic acid, —(C₁-C₅ alkyl)COOH or 2-methylenebenzo[d][1,3]dithiole; wherein X and Y are each independently oxygen, nitrogen, or sulfur, wherein the nitrogen is optionally substituted with C₁-C₃ alkyl or C₁-C₃ perfluoroalkyl; and wherein Q is nitrogen.

Examples of diarylethenes that can be used as photoactive materials include diarylperfluorocyclopentenes, diarylmaleic anhydrides, diarylmaleimides, or a combination comprising at least one of the foregoing diarylethenes. The diarylethenes are present as open-ring or closed-ring isomers. In general, the open ring isomers of diarylethenes have absorption bands at shorter wavelengths. Upon irradiation with ultraviolet light, new absorption bands appear at longer wavelengths, which are ascribed to the closed-ring isomers. In general, the absorption spectra of the closed-ring isomers depend on the substituents of the thiophene rings, naphthalene rings or the phenyl rings. The absorption structures of the open-ring isomers depend upon the upper cycloalkene structures. For example, the open-ring isomers of maleic anhydride or maleimide derivatives show spectral shifts to longer wavelengths in comparison with the perfluorocyclopentene derivatives.

Examples of diarylethene closed ring isomers include:

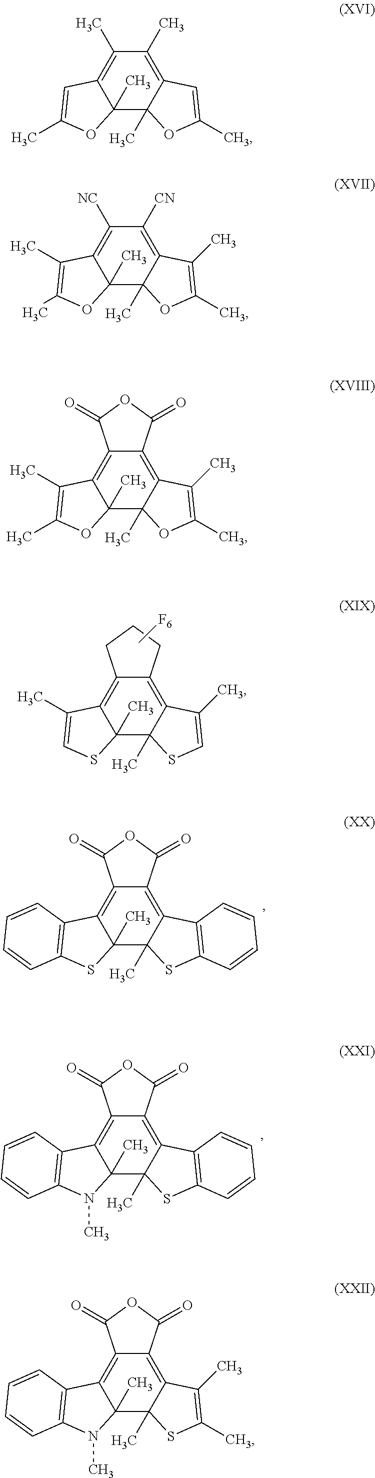

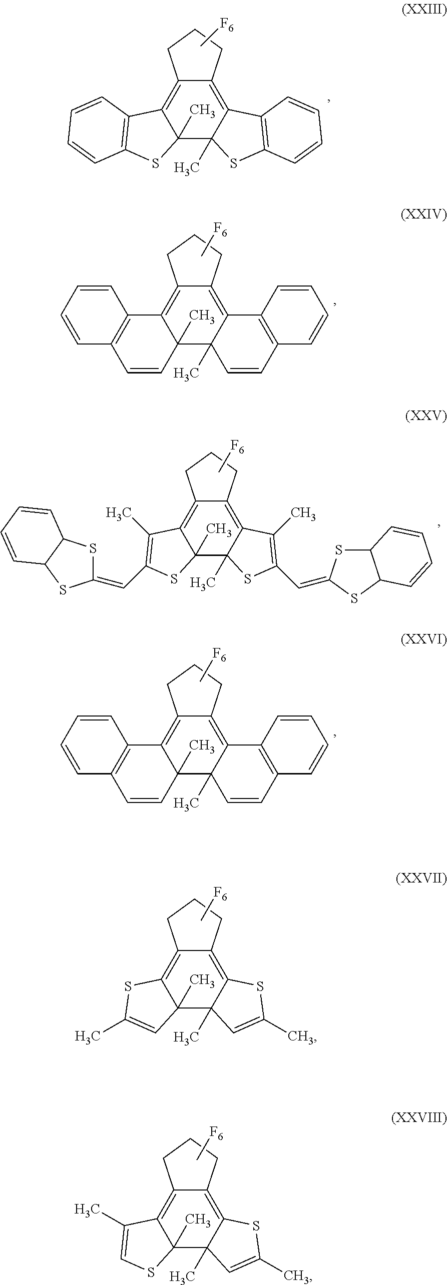

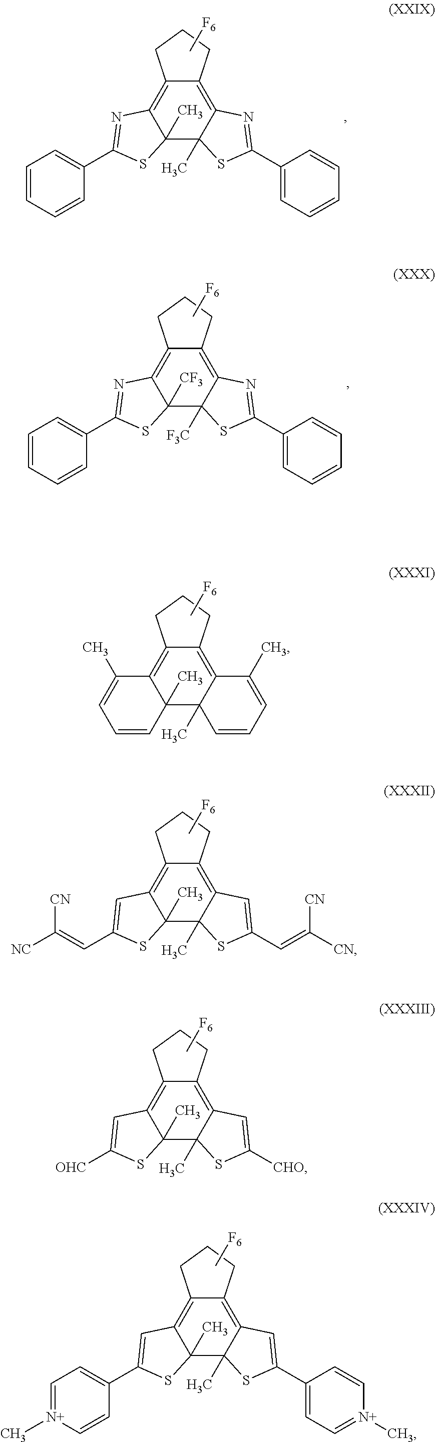

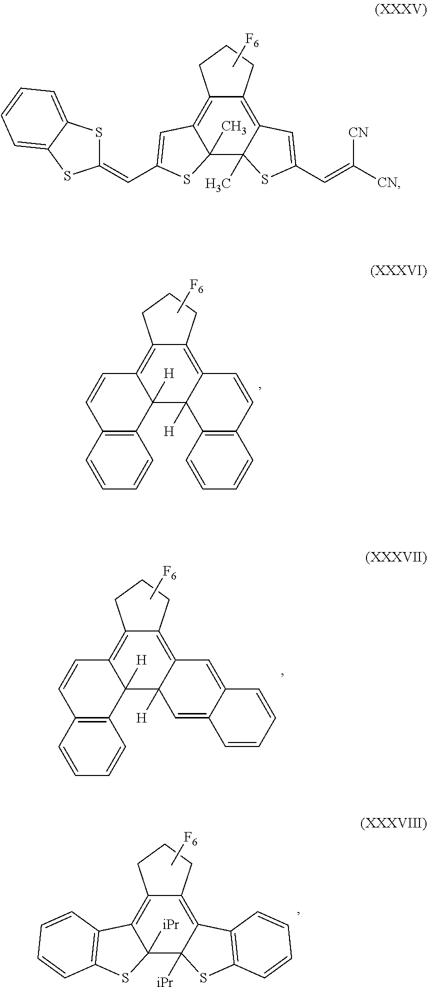

where iPr represents isopropyl;

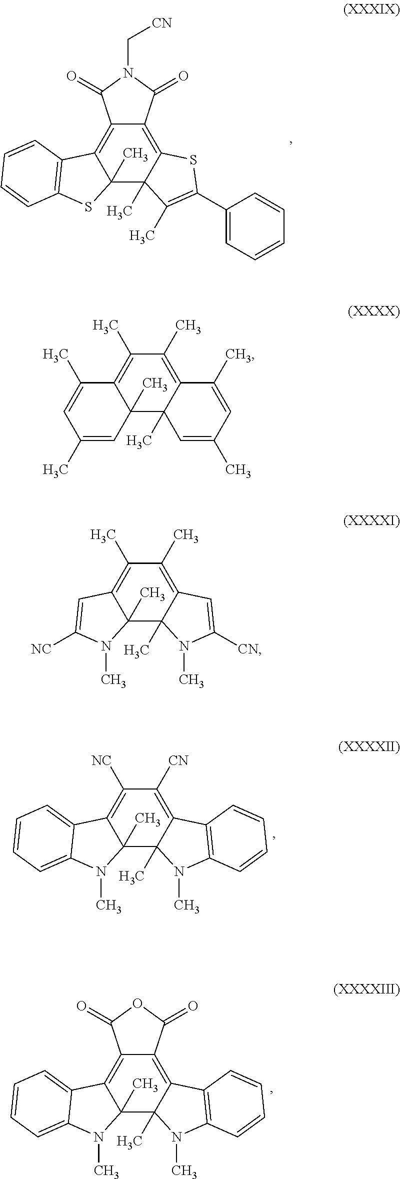

and combinations comprising at least one of the foregoing diarylethenes.

Diarylethenes with five-membered heterocyclic rings have two conformations with the two rings in mirror symmetry (parallel conformation) and in C₂ (antiparallel conformation). In general, the population ratio of the two conformations is 1:1. In one embodiment, it is desirable to increase the ratio of the antiparallel conformation to facilitate an increase in the quantum yield, which is further described in detail below. Increasing the population ratio of the antiparallel conformation to the parallel conformation can be accomplished by covalently bonding bulky substituents such as the —(C₁-C₅ alkyl)COOH substituent to diarylethenes having five-membered heterocyclic rings.

In another embodiment, the diarylethenes can be in the form of a polymer having the general formula (XXXXIV) below. The formula (XXXXIV) represents the open isomer form of the polymer.

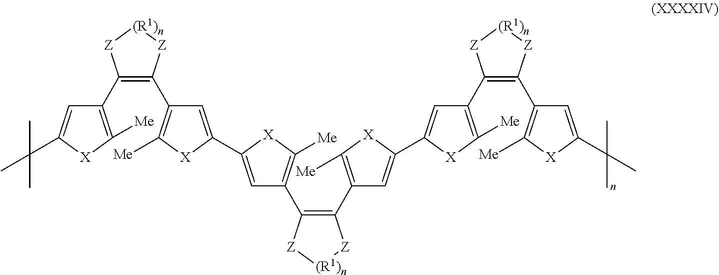

where Me represents methyl, R¹, X and Z have the same meanings as explained above in formulas (XI) through (XV) and n is any number greater than 1.

Polymerizing the diarylethenes can also be used to increase the population ratio of the antiparallel conformations to the parallel conformations.

The diarylethenes can be reacted in the presence of light. In one embodiment, an exemplary diarylethene can undergo a reversible cyclization reaction in the presence of light according to the following equation (I):

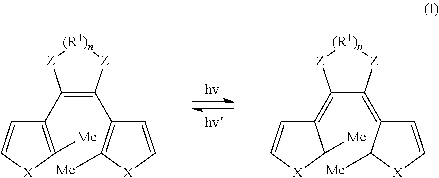

where X, Z R¹ and n have the meanings indicated above; and wherein Me is methyl. The cyclization reaction can be used to produce a hologram. The hologram can be produced by using radiation to react the open isomer form to the closed isomer form or vice-versa.

A similar reaction for an exemplary polymeric form of diarylethene is shown below in the equation (II)

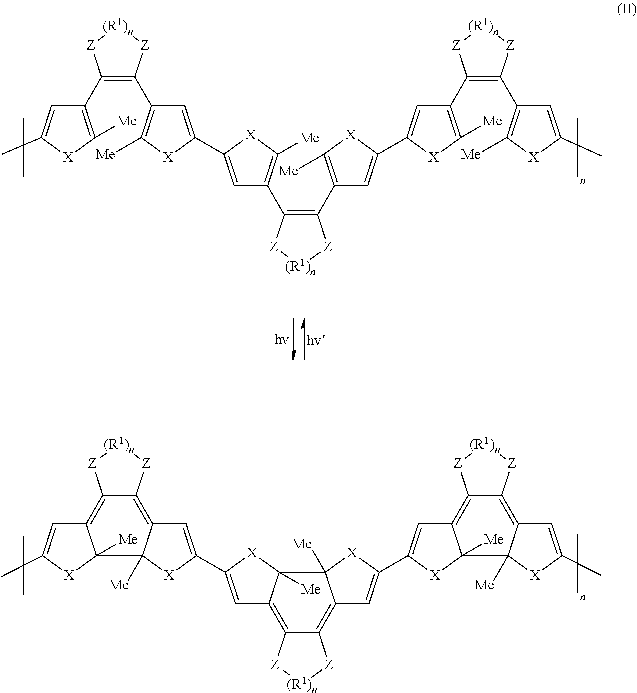

where X, Z R¹ and n have the meanings indicated above; and wherein Me is methyl.

Nitrones can also be used as photochromic dyes in the holographic storage media. Nitrones have the general structure shown in the formula (XXXXV):

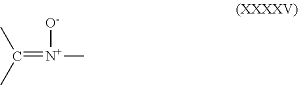

An exemplary nitrone generally comprises an aryl nitrone structure represented by the formula (XXXXVI):

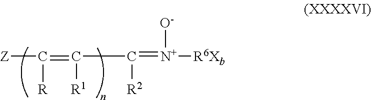

wherein Z is (R³)ₐ-Q—R⁴— or R⁵—; Q is a monovalent, divalent or trivalent substituent or linking group; wherein each of R, R¹, R² and R³ is independently hydrogen, an alkyl or substituted alkyl radical containing 1 to about 8 carbon atoms or an aromatic radical containing 6 to about 13 carbon atoms; R⁴ is an aromatic radical containing 6 to about 13 carbon atoms; R⁵ is an aromatic radical containing 6 to about 20 carbon atoms which have substituents that contain hetero atoms, wherein the hetero atoms are at least one of oxygen, nitrogen or sulfur; R⁶ is an aromatic hydrocarbon radical containing 6 to about 20 carbon atoms; X is a halo, cyano, nitro, aliphatic acyl, alkyl, substituted alkyl having 1 to about 8 carbon atoms, aryl having 6 to about 20 carbon atoms, carbalkoxy, or an electron withdrawing group in the ortho or para position selected from the group consisting of

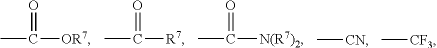

where R⁷ is a an alkyl radical having 1 to about 8 carbon atoms; a is an amount of up to about 2; b is an amount of up to about 3; and n is up to about 4.

As can be seen from formula (XXXXVI), the nitrones may be α-aryl-N-arylnitrones or conjugated analogs thereof in which the conjugation is between the aryl group and an α-carbon atom. The α-aryl group is frequently substituted, most often by a dialkylamino group in which the alkyl groups contain 1 to about 4 carbon atoms. The R² is hydrogen and R⁶ is phenyl. Q can be monovalent, divalent or trivalent according as the value of “a” is 0, 1 or 2. Illustrative Q values are shown in the Table 1 below.

TABLE 1

| Valency of Q | Identity of Q |
|---|---|
| Monovalent | fluorine, chlorine, bromine, iodine, alkyl, aryl; |
| Divalent | oxygen, sulphur, carbonyl, alkylene, arylene. |
| Trivalent | Nitrogen |

It is desirable for Q to be fluorine, chlorine, bromine, iodine, oxygen, sulfur or nitrogen.

Examples of nitrones are α-(4-diethylaminophenyl)-N-phenylnitrone; α-(4-diethylaminophenyl)-N-(4-chlorophenyl)-nitrone, α-(4-diethylaminophenyl)-N-(3,4-dichlorophenyl)-nitrone, α-(4-diethylaminophenyl)-N-(4-carbethoxyphenyl)-nitrone, α-(4-diethylaminophenyl)-N-(4-acetylphenyl)-nitrone, α-(4-dimethylaminophenyl)-N-(4-cyanophenyl)-nitrone, α-(4-methoxyphenyl)-N-(4-cyanophenyl)nitrone, α-(9-julolidinyl)-N-phenylnitrone, α-(9-julolidinyl)-N-(4-chlorophenyl)nitrone, α-[2-(1,1-diphenylethenyl)]-N-phenylnitrone, α-[2-(1-phenylpropenyl)]-N-phenylnitrone, or the like, or a combination comprising at least one of the foregoing nitrones. Aryl nitrones are particularly useful in the compositions and articles disclosed herein. An exemplary aryl nitrone is α-(4-diethylaminophenyl)-N-phenylnitrone.

Upon exposure to electromagnetic radiation, nitrones undergo unimolecular cyclization to an oxaziridine as shown in the structure (XXXXVII)

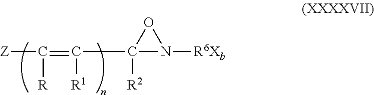

wherein R, R¹, R², R⁶, n, X_{b} and Z have the same meaning as denoted above for the structure (XXXXVI).

Nitrostilbenes and nitrostilbene derivatives may also be used as photoreactive dyes for recording interference fringe patterns, as disclosed for example by C. Erben et al., “Ortho-Nitrostilbenes in Polycarbonates for Holographic Data Storage,” Advanced Functional Materials, 2007, 17, 2659-66, and in U.S. Pat. App. Publ. No. 2008/0085492 A1, the disclosures of which are incorporated herein by reference in their entirety. Specific examples of such dyes include 4-dimethylamino-2′,4′-dinitrostilbene, 4-dimethylamino-4′-cyano-2′-nitrostilbene, 4-hydroxy-2′,4′-dinitrostilbene, and 4-methoxy-2′,4′-dinitrostilbene. These dyes have been synthesized and optically induced rearrangements of such dyes have been studied in the context of the chemistry of the reactants and products as well as their activation energy and entropy factors. J. S. Splitter and M. Calvin, “The Photochemical Behavior of Some o-Nitrostilbenes,” J. Org. Chem., vol. 20, pg. 1086 (1955). More recent work has focused on using the refractive index modulation that arises from these optically induced changes to write waveguides into polymers doped with the dyes. McCulloch, I. A., “Novel Photoactive Nonlinear Optical Polymers for Use in Optical Waveguides,” Macromolecules, vol. 27, pg. 1697 (1994).

In addition to the binder and the photoreactive dye, the holographic recording medium may include any of a number of additional components, including but not limited to heat stabilizers, antioxidants, light stabilizers, plasticizers, antistatic agents, mold release agents, additional resins, binders, and the like, as well as combinations of any of the foregoing components.

In one exemplary embodiment, the holographic recording medium is extruded as a relatively thin layer or film, e.g., having a thickness of 0.5 to 1000 microns. In another exemplary embodiment, a layer or film of the holographic recording medium is coated onto, co-extruded with, or laminated with a support. The support may be a planar support such as a film or card, or it may be virtually any other shape as well. In yet another exemplary embodiment, the holographic medium may be molded or extruded into virtually any shape capable of being fabricated by plastic manufacturing technologies such as solvent-casting, film extrusion, biaxial stretching, injection molding and other techniques known to those skilled in the art. Still other shapes may be fabricated by post-molding or post-extrusion treatments such as cutting, grinding, polishing, and the like.

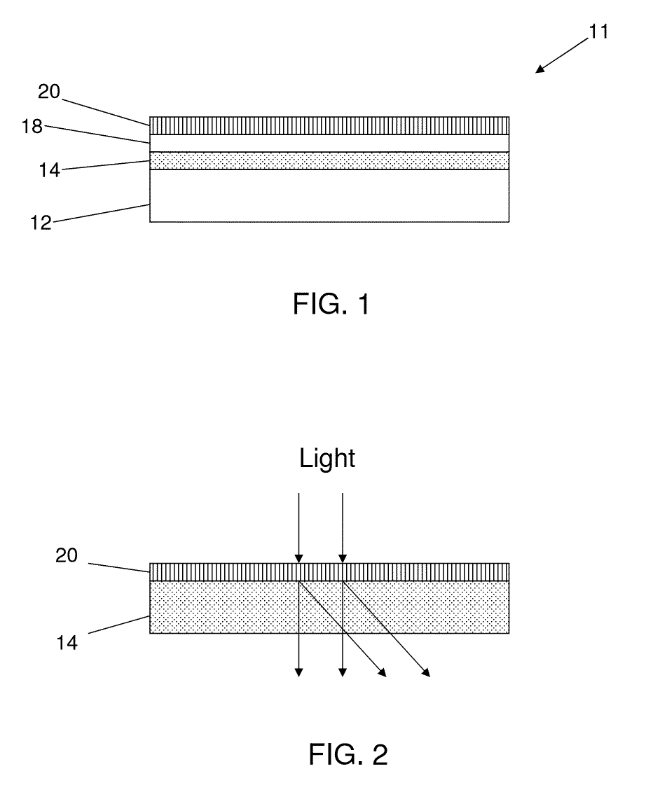

Turning now to FIG. 1, an exemplary structure of an article for recording and displaying a holographic record is shown. In this exemplary embodiment, an article 11 comprises a support layer 12 having thereon a layer of holographic recording medium 14 and a top-coat layer 18. The support layer 12 should be transparent if the holographic record is to be a transmission hologram, or it may be transparent or opaque if the holographic record is to be a reflection hologram. The top-coat layer 18 should be transparent. Either of the support layer 12 and the top-coat layer 18 may include or have added after exposure one or more light-blocking moieties to help stabilize the record to be recorded in holographic recording medium 14. The support may be a planar support such as a film or card, or it may be virtually any other shape as well. Exemplary supports and top-coat materials may include any of the same materials described above for use as a binder for the holographic recording medium. Disposed over top-coat layer 18 temporarily during recording of the holographic record is the spatially homogeneous optical diffraction element 20, for transmitting and diffracting light. By spatially homogeneous, it is meant that the optical diffraction element has a diffraction grating having spacing that is uniform throughout the element or has sections where the spacing is uniform. This is distinguished from a holographic diffraction grating that has image or other information encoded into a diffraction grating pattern. Spatially homogeneous diffraction gratings can be produced using relatively simple and inexpensive manufacturing techniques that are well-known in the art, and are widely commercially available. In an exemplary embodiment, the diffraction grating is a surface diffraction grating that diffracts light with a spatially homogeneous pattern of peaks and valleys on the surface of the element. In another exemplary embodiment, the diffraction grating is a volume diffraction grating that diffracts light with a spatially homogeneous pattern of varying refractive indices in the body of the element. The specific characteristics of the optical diffraction element will be chosen to produce interfering exposure beams in the holographic recording medium at the desired angles and spacings to generate a transmission or reflection, monochromatic or polychromatic, holographic recording therein, and will be based on the exposure wavelength that will be used to expose the holographic recording medium, the incident angle of the exposing beam, the refractive indices of the layers, and the desired viewing geometries for the holograms that are created. One exemplary spatially uniform optical diffraction element is Edmund Optics 82970110 Grating Sheet, 1000 lines/mm. Other such elements are well-known in the art.

A holographic record can be recorded in the holographic recording medium 14 by selectively exposing the article 11 to a coherent beam of actinic radiation at a wavelength or range of wavelengths to which the holographic recording medium is sensitive. The intensity and duration of exposure to actinic radiation needed may vary depending on the specific characteristics of the holographic recording medium involved, object thickness, coloration of intervening layers and other such factors. While the intensity and duration of exposure to actinic radiation may vary widely, it can be readily determined by one skilled in the art with simple experimentation and optimization of the processing conditions. Furthermore, as used herein, the terms “actinic radiation” and “light” are used interchangeably to refer to “actinic radiation”, even though some of the actinic radiation wavelengths may fall outside the visible light spectrum. In an exemplary embodiment, the spatially homogeneous optical diffraction element is removable from the article 11, i.e., it is physically integrated as part of the article, but is configured to be readily removed (e.g., peel-away) after exposure of the holographic recording medium.

Actinic radiation may be selectively applied to the spatially homogeneous optical diffraction element to be diffracted and directed into the holographic recording medium for any of a variety of purposes, including but not limited to generating a holographic image, generating a decorative pattern or other shape or logo such as for display, advertising, aesthetic, artistic or secure identification purposes, or for storing information. In one exemplary embodiment, the actinic radiation may be projected through a patterning device. Exemplary patterning devices include, but are not limited to metalized or inked masks and/or filters (which may or may not contain gradients in opacity to manipulate features in the final hologram), physical masks, as well as adjustable and/or configurable optical control devices such as binary micro mirror-based light modulators, grayscale LCD spatial light modulators, or other optical control devices known in the art. The patterning device may be stacked with the holographic recording medium or it may be disposed physically separated from the recording medium and disposed along the optical path between the actinic radiation source and the recording medium. If the mask or other patterning device is stacked with the holographic recording medium, it may be disposed ‘upstream’ or ‘downstream’ of the spatially homogeneous optical diffraction element along the optical path of light traveling to the holographic recording medium and, like the optical diffraction element, may be configured to be readily removed (e.g., peel-away) after exposure of the holographic recording medium. A focused, coherent light source such as a laser or may be used with a patterning device (the term “mask” will be used below for ease of use, but it is understood that other patterning devices may be applicable as well). If the actinic radiation directed onto the recording medium does not cover an area sufficiently large to cover the unmasked portions of the recording medium, a scanning beam (defined as any movable projection of coherent actinic radiation) may be used to cover the desired areas.

In another exemplary embodiment, the masked recording medium may be moved below a stationary projected actinic radiation source. If the projection of actinic radiation is not sufficiently large to cover the unmasked portions of the recording medium, the direction of motion of the recording medium may be varied as needed so that all desired areas are exposed to actinic radiation. In an exemplary embodiment where the masked recording medium is moved in a linear direction (e.g., for efficiency of production), the projection of actinic radiation may be moved back and forth in a direction perpendicular to the direction of motion of the recording medium if it is not large enough to cover the unmasked portions of the recording medium.

A mask may be used, but it is not required, for example, if the actinic radiation is selectively applied by a focused or coherent actinic radiation source, such as a laser or optically focused actinic radiation source. In such an exemplary embodiment, a scanning focused or coherent actinic radiation beam may be used to selectively expose desired locations or areas of the holographic recording medium. Regular 2-dimensional x-y scanning may be used, or irregular (i.e., free-form) scanning may be used. In addition to or as an alternative to the use of a scanning actinic radiation beam, the holographic recording medium may be moved with respect to the location of a focused or coherent actinic radiation beam in order to selectively expose desired locations or areas of the holographic recording medium. In an exemplary embodiment where the recording medium is moved in a linear direction (e.g., for efficiency of production), the projection of actinic radiation may be moved back and forth in a direction perpendicular to the direction of motion of the recording medium (i.e., one-dimensional scanning).

A scanning beam (whether raster scanning, one-dimensional scanning, or free-form scanning) may have motion imparted to it in a variety of ways well-known in the art, such as robotic control or manual control of the actinic radiation source. Also, in addition to being used as patterning devices as described above, optical control devices such as movable lenses or mirrors (including micro-mirrors, e.g., in binary micro-mirror array devices) may be used to impart motion to the light source. Additionally, as is known in the art, the light source may be started and stopped, periodically blocked, or have its intensity varied while scanning to provide the desired exposure profile to the holographic recording medium.

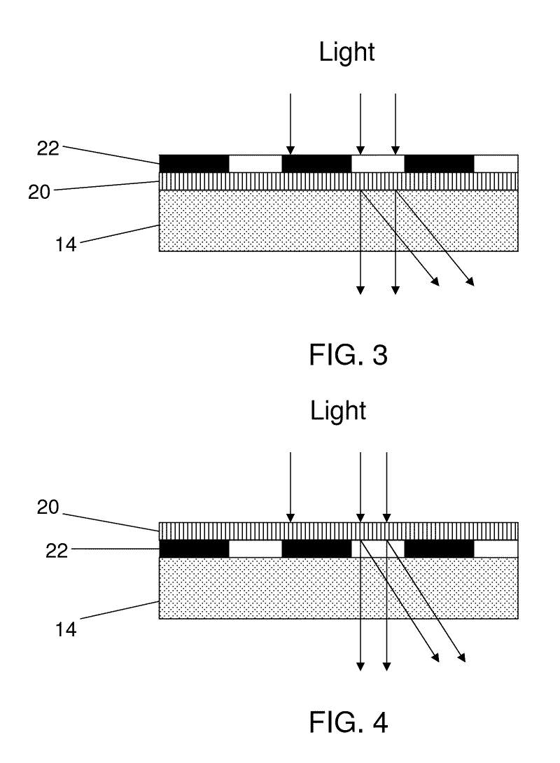

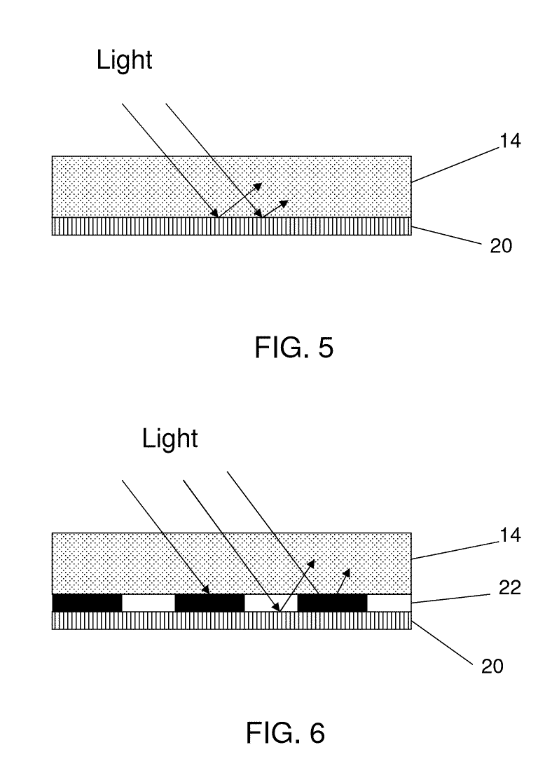

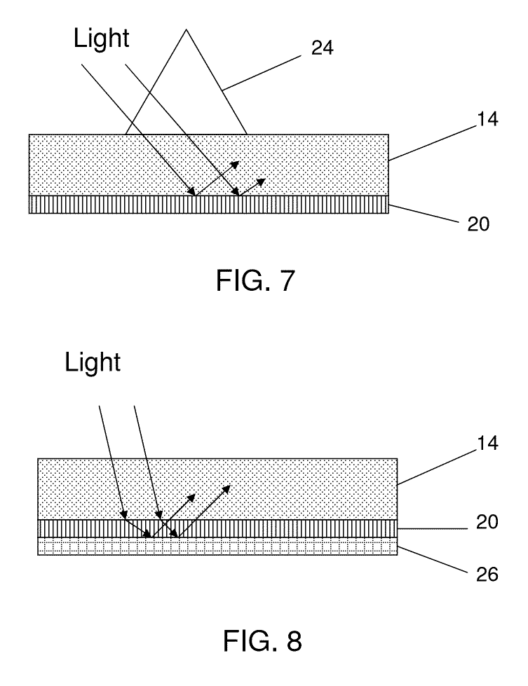

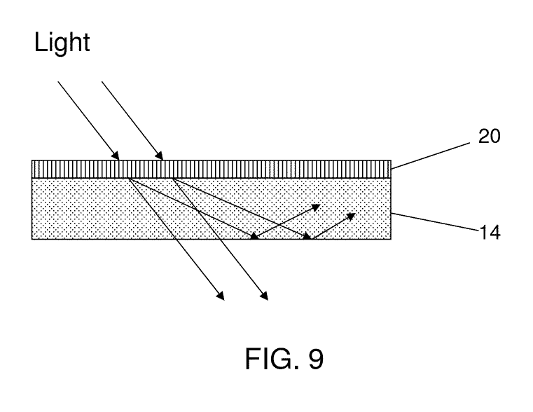

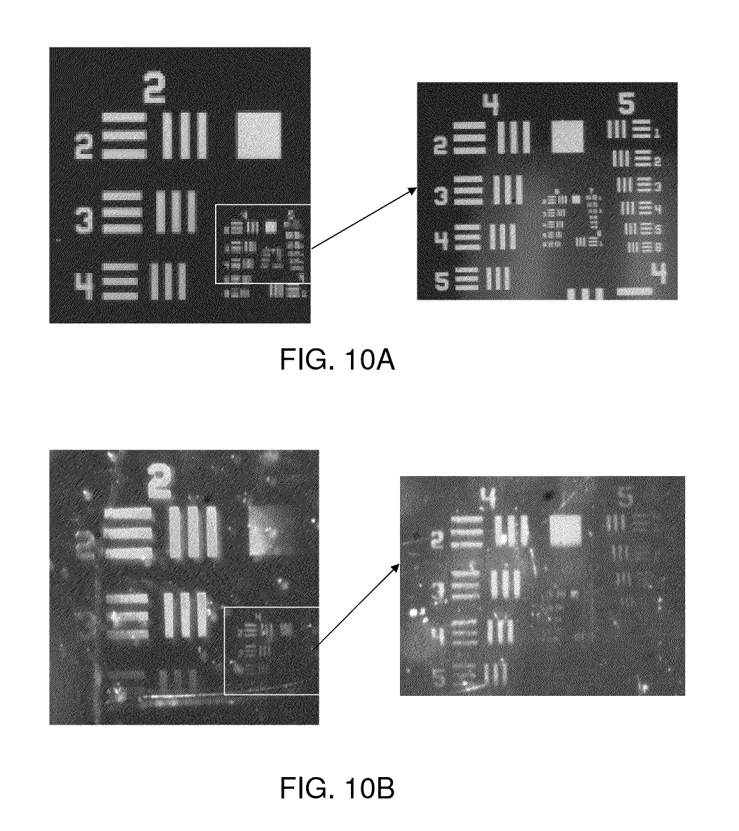

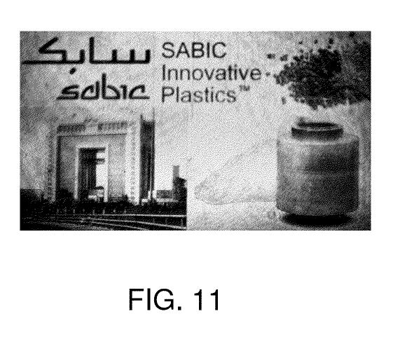

Turning now to FIGS. 2-9, exemplary embodiments are illustrated of different configurations for recording holographic records. For simplicity of illustration, elements such as supports, top coat layers, light filtering layers, and the like are omitted from FIGS. 2-9, which depict only the spatially homogeneous optical diffraction elements, masks, and holographic recording media. FIG. 2 depicts the recording of a transmission hologram in holographic recording medium 14, with light beams from above shown being diffracted and transmitted through a spatially homogeneous transmission optical diffraction element 20 disposed over the holographic recording medium. FIG. 3 depicts the same recording configuration as FIG. 2, with the addition of mask element 22 over the optical diffraction element for imparting an image, shape, or pattern to the hologram. FIG. 4 depicts the same recording configuration as FIG. 2, with the addition of mask element 22 underneath the optical diffraction element for imparting an image, shape, or pattern to the hologram. FIG. 5 depicts the recording of a reflection hologram in holographic recording medium 14, with light beams from above shown being transmitted through the holographic recording medium and then being diffracted and reflected back into the holographic recording medium from a reflective spatially homogeneous optical diffraction element disposed below the holographic recording medium. FIG. 6 depicts the same recording configuration as FIG. 5, with the addition of mask element 22 over the holographic recording medium for imparting an image, shape, or pattern to the hologram. In an alternative exemplary embodiment, the mask 22 could be disposed between the holographic recording medium 14 and the optical diffraction element 20. FIG. 7 depicts the same recording configuration as FIG. 5, with the addition of a prism 24 disposed over the holographic recording medium to provide light beams at angles of incidence greater than the critical angle, as described in U.S. patent application Ser. No. 13/028,529 filed Feb. 16, 2011, for the purpose of generating a reflection hologram which diffracts light centered at a wavelength other than the recording wavelength. FIG. 8 depicts the same recording configuration as FIG. 5, but with a transmission spatially homogeneous optical diffraction element used instead of a reflective optical diffraction element, and with the addition of a specular reflective element or layer 26 disposed below the optical diffraction element to reflect light back toward the holographic recording medium. Lastly, FIG. 9 depicts the recording of a reflection hologram in holographic recording medium 14, with light beams from above shown being diffracted and transmitted through a transmission spatially homogeneous optical diffraction element 20 disposed over the holographic recording medium such that the diffracted beams propagate through the holographic recording medium at an angle of incidence greater than the critical angle so that they are internally reflected at the air/recording medium interface at the bottom.

In an exemplary embodiment, upon completion of the shape, pattern or image recording process, the holographic recording medium (and more specifically, the interference fringe pattern recorded therein) is stabilized towards further bleaching, removal or deactivation of the remaining interference fringe patterns through chemical stabilization techniques to prevent loss of hologram intensity (e.g., by chemically converting unreacted photoreactive dye into a different form that is no longer light sensitive in the case of photoreactive dye-based holograms), or by physical stabilization techniques (e.g., by protecting the holographic recording medium with a protective layer that absorbs light in the wavelengths to which holographic medium is sensitive). Exemplary stabilization techniques are disclosed in US patent application publ. no. 2010/0009269 A1, U.S. Pat. No. 7,102,802 B1 and U.S. patent application Ser. No. 13/028,807 filed on Feb. 16, 2011, the disclosures of which are incorporated herein by reference in their entirety.

The techniques described herein may be used to provide multiple holographic images in an article. For example, discrete segments of holographic recording media may be disposed in an article and be selectively exposed through a spatially homogeneous optical diffraction element to produce multiple holographic records in the article. In an alternative exemplary embodiment, a single area of holographic recording medium may have discrete segments selectively exposed through the optical diffraction element to produce multiple holographic records (i.e., patterns, shapes or images) in the article. In other exemplary embodiments, holographic records may be spatially or angularly multiplexed in the same area of the article (either occupying the same space in the holographic recording medium or in overlying layers of holographic recording media) to produce holographic records that display different colors or that display at different angles. In such embodiments, multiple exposures through the same or different spatially homogeneous optical diffraction elements may be needed to produce the multiplexed records such as multicolor holographic images or holographic images that display at a variety of angles. Some spatial and angular multiplexing geometries may also be accomplished by combining multiple diffraction gratings arrayed at specified angles or locations with respect to each other during a single exposure. The above-mentioned spatially and angularly multiplexed holograms may (in a single article) have the same or different optical characteristics, such as recording and viewing geometries that can lend unique optical characteristics to the holograms recorded in different areas of the holographic article. For example, reflection holograms (of different colors) and transmission holograms may be recorded in the same holographic film or the same holographic article. Holograms recorded in the same holographic film or article may also have different intensities, angles of view, peak wavelengths, or requirements for viewing (e.g., covert holograms requiring the use of a prism to view or overt holograms viewable without the assistance of a prism).

It is understood that modifications of the various embodiments of this invention are also included within the description of the invention provided herein. Accordingly, the following examples are intended to illustrate but not limit the present disclosure.

### Example 1

A stack comprising a mask (a USAF 1951 resolution chart mask specially designed to quantify image resolution), spatially homogeneous optical diffraction element (Edmund Optics 82970110 Grating Sheet, 1000 lines/mm), and holographic film (8 wt. % α-(4-Methoxycarbonylphenyl)-N-(4-Ethoxycarbonylphenyl) Nitrone in high-flow/ductile polycarbonate, 150 μm film) were fastened together in the order shown in FIG. 3, and this construct was exposed from above using a hand-held laser pointer (Wicked Lasers SNR40501˜150 mW 405 nm handheld laser pointer or a SunValleyTek 10 mW 405 nm Blue Laser Pointer). The sample stack was affixed with binder clips to prevent motion of the layers with respect to each other. No special vibration isolation procedures were performed other than to assure that the sample stack was firmly clipped, to prevent relative motion between the film layers. Tests were performed with and without water as an index coupling fluid between the layers with no difference in the results. The laser pointer, which produced a 2 mm diameter spot, was moved relative to the sample stack over the region of the USAF mask that was to be duplicated. The direction of the laser beam incident upon the plane of the sample stack was kept constant. Tests were performed by moving the sample stack or by moving the laser pointer or by moving both sample stack and laser pointer with no difference in the results. A typical result is shown in FIG. 10A, where FIG. 10A displays an image of the mask original at two different magnifications, and FIG. 10B displays an image of the corresponding hologram at the same magnifications.

### Example 2

A second technique to record holographic images with contact replication was demonstrated by encoding an image onto a laser beam through the use of a spatial light modulator (SLM) or digital light processor (DLP). Experiments were performed using the light from a 405 nm laser, (Toptica Photonics, model—BlueMode) which was projected onto an SLM (HOLOEYE Photonics, model HED 6001) and then focused onto a stack of a spatially homogeneous optical diffraction element (Edmund Optics Edmund Optics, part number NT40-267 82970110), and holographic film (8 wt. % α-(4-Methoxycarbonylphenyl)-N-(4-Ethoxycarbonylphenyl)Nitrone in high-flow/ductile polycarbonate, 150 μm film) clipped together in the order shown in FIG. 2 using a series of optical components including a beam expander, filter, mirrors, and lenses in addition to the SLM to direct the beam onto the stack. Images were recorded into the holographic film, with images ranging in size from 1″×1.7″ to 5″×7″, by varying the imaging optics to yield the different magnification levels. The diffraction gratings used were manufactured by. FIG. 11 shows a typical image recorded with this technique.

All ranges disclosed herein are inclusive of the endpoints, and the endpoints are independently combinable with each other (e.g., ranges of “up to 25 wt. %, or, more specifically, 5 wt. % to 20 wt. %”, is inclusive of the endpoints and all intermediate values of the ranges of “5 wt. % to 25 wt. %,” etc.). “Combination” is inclusive of blends, mixtures, alloys, reaction products, and the like. Furthermore, the terms “first,” “second,” and the like, herein do not denote any order, quantity, or importance, but rather are used to denote one element from another. The terms “a” and “an” and “the” herein do not denote a limitation of quantity, and are to be construed to cover both the singular and the plural, unless otherwise indicated herein or clearly contradicted by context. The suffix “(s)” as used herein is intended to include both the singular and the plural of the term that it modifies, thereby including one or more of that term (e.g., the film(s) includes one or more films). Reference throughout the specification to “one embodiment”, “another embodiment”, “an embodiment”, and so forth, means that a particular element (e.g., feature, structure, and/or characteristic) described in connection with the embodiment is included in at least one embodiment described herein, and may or may not be present in other embodiments. In addition, it is to be understood that the described elements may be combined in any suitable manner in the various embodiments.

While typical embodiments have been set forth for the purpose of illustration, the foregoing descriptions should not be deemed to be a limitation on the scope herein. Accordingly, various modifications, adaptations, and alternatives can occur to one skilled in the art without departing from the spirit and scope herein.

1. A method of recording a volume holographic pattern, shape, or image, comprising:
exposing a holographic recording medium to a coherent light source emitting light at one or more wavelengths to which the holographic recording medium is sensitive, wherein the light to which the holographic recording medium is exposed is diffracted by a spatially homogeneous optical diffraction element, such that the holographic recording medium is exposed to a plurality of interfering light beams, thereby forming a holographic pattern, shape, or image in the holographic recording medium.

2. The method of claim 1, further comprising removing the optical diffraction element after recording the holographic record.

3. The method of claim 1, wherein the optical diffraction element is a surface diffraction grating.

4. The method of claim 1, wherein the optical diffraction element is a volume diffraction grating.

5. The method of claim 1, wherein the optical diffraction element is a reflection diffraction grating and the light from the coherent light source is directed through the holographic recording medium and is then diffracted back into the holographic recording medium.

6. The method of claim 5, wherein the optical diffraction element comprises a transmission diffraction grating and a reflection diffraction grating.

7. The method of claim 1, wherein the optical diffraction element comprises a transmission diffraction grating or a plurality of transmission diffraction gratings.

8. The method of claim 7, wherein the optical diffraction element is disposed over the holographic recording medium along the optical path between the coherent light source and the holographic recording medium.

9. The method of claim 7, wherein the optical diffraction element is disposed over a specular reflective surface and the holographic recording medium is disposed over the optical diffraction element, and the light from the coherent light source is directed through the holographic recording medium and is then diffracted by the transmission diffraction grating and reflected back into the holographic medium by the specular reflective surface.

10. The method of claim 1, further comprising directing light from the coherent light source through a mask element to expose the holographic recording medium to the desired pattern, shape, or image.

11. The method of claim 10, wherein the optical diffraction element is disposed over the holographic recording medium and the mask element is disposed over the optical diffraction element, along the optical path between the coherent light source and the holographic recording medium.

12. The method of claim 10, wherein the mask element is disposed over the holographic recording medium and the optical diffraction element is disposed over the mask element, along the optical path between the coherent light source and the holographic recording medium.

13. The method of claim 10, wherein the mask element is disposed over the optical diffraction element that is either a transmission diffraction grating disposed over a specular reflective surface or a reflection diffraction grating, and the holographic recording medium is disposed over the mask element, and the light from the coherent light source is directed through the holographic recording medium and the mask and is then diffracted back through the mask into the holographic recording medium.

14. The method of claim 10, wherein the mask element is disposed over the holographic recording medium and the holographic recording medium is disposed over the optical diffraction element that is either a transmission diffraction grating disposed over a specular reflective surface or a reflection diffraction grating, and the light from the coherent light source is directed through the mask element and the holographic recording medium and is then diffracted and directed back into the holographic recording medium.

15. The method of claim 10, wherein the holographic recording medium is disposed over the optical diffraction element that is a transmission diffraction grating disposed over the mask element, and the mask element is disposed over a specular reflective surface, and the light from the coherent light source is directed through the holographic recording medium and is then diffracted by the optical diffraction element through the mask element and reflected back into the holographic recording medium by the specular reflective surface.

16. The method of claim 1, wherein a light modulator is used to provide the desired pattern, shape or image from the coherent light source.

17. The method of claim 16, wherein the light modulator is a grayscale spatial light modulator.

18. The method of claim 16, wherein the light modulator is a binary micro mirror-based light modulator.

19. The method of claim 1, wherein the desired pattern, shape or image is provided by scanning the coherent light source over a desired area of the holographic recording medium.

20. The method of claim 1, wherein the desired shape, pattern or image is provided by a coherent light source having robotically controlled aim.

21. The method of claim 1, wherein the desired shape, pattern or image is provided by a coherent light source aimed by hand.

22. The method of claim 1, further comprising directing light from the coherent light source by a transparent refracting medium optically coupled with an article comprising the holographic recording medium and the spatially homogeneous optical diffraction element, wherein the light from the coherent light source passes through the transparent refracting medium before entering the holographic recording.

23. The method of claim 22, wherein the transparent refracting medium is a glass, crystal or plastic prism.

24. The method of claim 22, wherein the transparent refracting medium is a spherical or cylindrical lens.

25. The method of claim 22, wherein a liquid or gel transparent refracting material is used to enhance optical coupling.

26. The method of claim 1, wherein the holographic recording medium comprises a transparent binder and a photoreactive dye.

27. The method of claim 1, wherein the holographic recording medium comprises a photocrosslinkable polymer.

28. The method of claim 1, wherein the holographic recording medium comprises a dichromated gelatin or metal halide composition.

29. An article for recording a hologram, comprising a holographic recording medium and a spatially homogeneous optical diffraction element.

30. The article of claim 29, wherein the optical diffraction element is removable.

31. The article of claim 30, further comprising a removable element capable of having an optical mask printed thereon.

32. A holographic article produced by the method of claim 1.

33. A holographic article produced by the method of claim 2.

34. A holographic article produced by the method of claim 5.

35. A holographic article produced by the method of claim 7.

36. A holographic article produced by the method of claim 8.

37. A holographic article produced by the method of claim 9.

38. A holographic article produced by the method of claim 10.

39. A holographic article produced by the method of claim 16.

40. A holographic article produced by the method of claim 19.

41. A holographic article produced by the method of claim 26.

42. A holographic article produced by the method of claim 27.

43. A holographic article produced by the method of claim 28.
